(19) United States
(12) Patent Application Publication
(10) Pub. No.: US 2021/0358513 A1
(43) Pub. Date: Nov. 18, 2021

(54) A SOURCE SEPARATION DEVICE, A METHOD FOR A SOURCE SEPARATION DEVICE, AND A NON-TRANSITORY COMPUTER READABLE MEDIUM

(71) Applicant: NEC Corporation, Minato-ku, Tokyo (JP)

(72) Inventors: Chaitanya Prasad NARISETTY, Tokyo (JP); Tatsuya KOMATSU, Tokyo (JP); Reishi KONDO, Tokyo (JP)

(73) Assignee: NEC Corporation, Minato-ku, Tokyo (JP)

(21) Appl. No.: 17/286,095

(22) PCT Filed: Oct. 26, 2018
(86) PCT No.: PCT/JP2018/039997

§ 371 Date: Apr. 16, 2021

(51) Int. Cl. G10L 21/0272; G10L 25/03

(52) U.S. Cl. CPC G10L 21/0272; G10L 25/03

(57) ABSTRACT

A purpose of the present disclosure is to provide a source separation method, a non-transitory computer readable medium, and a source separation apparatus. The source separation apparatus includes an input means for inputting mixture data obtained by mixing a plurality of data; and a matrix decomposition means for separating the input mixture data by estimating a mixing/unmixing matrix, a basis matrix for each source, an activations matrix for each source and a reliability vector for each source, and a means for unmixing of input mixture data using the estimated matrices from the matrix decomposition means to estimate the sources.

### TECHNICAL FIELD

The present invention relates to a source separation method, source separation program and source separation device using Matrix Decompositions improved with a non-parametric estimation of source complexities. The present invention more closely relates to a method, program and device for acoustic source separation to separate multiple audio sources, given an audio data input containing a mixture of said audio sources.

### BACKGROUND ART

The focus of the present invention is a separation of sources (source signals) from a set of mixture signals in which the sources have been mixed among themselves. An often referred example is the cocktail party problem where many people are talking are talking simultaneously and a person in the party wants to focus only one discussion or only one person. This non-trivial problem is extensively studied especially in the field of audio source separation. The methods used for the audio source separation are general and can be extended to other fields of medical imaging where the desired source signal (magnetic fields) is corrupted by the undesired signals (nose) of measuring equipment like the movement of a wrist watch. Models used in such applications can be used in noise removal in audio separation as well. Thus, source separation is of significant importance and contains core methods that span across many fields. For consistency, the present invention will henceforth be written in the context of audio source separation.

In audio source separation, the aim is to separate two or more audio signals occurring at the same time that are being captured by at least one microphone. A typical framework for this application is shown in FIG. 1, where N audio signals are being captured simultaneously by a set of microphones 502s which are then fed to the ‘source separation’ block 501 to output a set of ‘N’ separated audio signals. That is, each microphone 502 captures a combined audio signal of all the ‘N’ audio sources S₁ to S_{N}. So, the effectiveness of the source separation determines the extent to which the separated sources resemble the original sources. There are many parameters that, if known, can be helpful for separation. Typical parameters include number of sources, location of sources, location of microphones, reverberation of surrounding environment etc. These parameters can greatly aid in the separation. However most of them are unknown in a real world situation. This is known as a blind source separation problem where we are blind to parameters of framework shown in FIG. 1.

For understanding the method detailed in the present invention, we will first explain the blind source separation (BSS) framework detailed in prior art NPL 1, which proposed a matrix decomposition method for BSS. The motivation behind this method is that audio signals of each microphone are obtained from linearly mixing (simple addition) audio source signals and hence can be linearly unmixed to retrieve the original sources.

In addition to the linear unmixing of audio sources, each source is also modelled simultaneously. This modelling is also done using matrix decomposition. So in total, the microphone signals are linearly unmixed (using matrix decomposition) to get source signals while modelling each source using matrix decomposition. The motivation behind the second matrix decomposition is that the features of typical audio signals are linear combinations of a much smaller set of features.

Matrix Decomposition techniques are effective in extracting linear factors which help to extract the correlations among a set of feature vectors. The matrix with its columns as feature vectors (X) is decomposed into a basis matrix (B) and activations matrix (H) such that

X≅BH, where ≅

denotes an approximate equality. In other words, the feature matrix is approximated by a linear combination of a small set of basis vectors. One of the popular examples is the Non-Negative Matrix Factorization (NMF). If the matrix decomposition, when B is fixed, it is termed as Supervised NMF. If B is estimated using NMF with and without prior information, it is termed as Semi-Supervised and Un-Supervised respectively.

In NPL 1, the multi-channel audio signal data is fed as input along with the complexity of each source that is to be separated. There can be several ways to define complexity of a source. One such definition used in the present invention is number of features that are sufficient to linearly model the entire feature matrix of a source. This is same as the number of basis vectors used in the decomposition of a source using NMF.

FIG. 6 showing the block diagram of NPL 1 contains the Data Input block 301, Matrix Decomposition block 302 and the Data Output block 303. The Data Input block 301 contains the multi-channel audio data obtained from microphones, complexity of each source and number of sources to be separated (this is optional). The Matrix Decomposition block 302 is an optimization block which decomposes the features of the multi-channel audio data until convergence using the Estimate Mixing/Unmixing Parameters block 3021, Multi-Source Modelling using the Parameter for Complexity of Each Source block 3022 and the Un-mix and Estimate Individual Audio Sources block 3023. As the name suggests, block 3021 estimates the mixing/unmixing parameters of audio sources. Here we write the term “mixing/unmixing” because source signals can be extracted by either estimating the mixing parameters (which model how sources are most-likely added to get mixtures) or by estimating the unmixing parameters (which model how mixtures can be most-likely unmixed to get sources). In a typical Matrix Decomposition block 302, this estimation of mixing/unmixing parameters is done by estimating a mixing matrix or an unmixing matrix, depending on the way sources are modelled with respect to the mixtures. Therefore we assume that it is sufficient to estimate one of these two matrices, i.e. if one of them is estimated, the other can be too. Throughout the present invention, it is understood that mixing parameters and unmixing parameters convey similar information. Block 3022 models all the sources separately as linear mixtures of basis and activations vectors using their respective complexity parameter (# of basis vectors) and finally the block 3023 unmixes the multi-channel audio data using the estimated mixing parameters and estimates the audio sources. After the convergence of matrix decomposition, the separated audio sources are outputted as block 303. The motivation of performing multi-source modelling is to enhance the performance of estimating the mixing parameters by representing the sources using a few features sufficient to model sources. This low-dimensional multi-source modelling helps the mixing parameters estimation block to avoid certain local minima.

Matrix Decomposition block 302 contains the estimation of mixing parameters and also the separate modelling of each source. Putting these two together, block 302 decomposes the microphone data into three parts. First part is the mixing/unmixing matrix, second part is a set containing the basis matrices of each source and third part is a set containing the activation matrices of each source. A source's basis matrix and its corresponding activation matrix together model the source. Then all of these sources are mixed using the mixing parameters to approximate microphone mixture signals.

Note that in NPL 1, the numbers of sources are known beforehand and this information is used for the matrix decomposition. However, prior art NPL 3 has similar block diagram which does not require the number of sources to be specified. This is to say that general methods with known number of sources can be extended to when number of sources is unknown.

In NPL 1, the method requires a complexity parameter for each of the sources. NPL 1 can be extended in the way sources are modelled as proposed in prior art NPL 2. Instead of providing complexity parameter for each source, NPL 2 asks for only one parameter which specifies the combined complexity of all sources. FIG. 7 showing the block diagram for NPL 2 is similar to NPL 1 except for the Data Input block 401 and the Multi-Source Modelling using the Parameter for Combined Complexity for All Sources block 4022. Block 401 differs from block 301 such that, instead of specifying the complexity of each source, the combined complexity of all sources is specified. Accordingly block 4022 only uses the combined complexity parameter for modelling the audio sources.

It is above mentioned that NPL 1 uses Matrix Decomposition to get three parts—a mixing/unmixing matrix, set containing each source's basis matrix and another set containing each source's activations matrix. In NPL 2, the combined complexity of all sources is specified and the method itself allocates the appropriate fraction of combined complexity to each source. This is done by decomposing the multi-channel microphone data using Matrix Decomposition block 402 into four parts—a mixing/unmixing matrix, a partition matrix, a basis matrix containing all the feature vectors sufficient to model all the sources and an activations matrix containing the activation vectors corresponding to the basis vectors.

The newly added partition matrix indicates which/how much of a particular basis is allocated to a particular source. For example: basis #1 belongs to source #1, basis #2 is shared between source #1 and #2 with respective weightage of 40% and 60% etc. Note that the sum of contributions of a particular basis to all sources should be 100%. In above example, basis #1 contributes 100% to source #1, and basis #2 distributes its contribution as 40% and 60% among source #1 and source #2.

To summarize, the first prior art shows a matrix decomposition based source separation method which models the microphone signals as a mixture of several audio source signals and decomposes the features of each source into basis and activations matrices. The second prior art is a variant of matrix decomposition based source separation method which models the microphone signals as a mixture of several source signals and decomposes the overall source signals into a common basis matrix, activations matrix and a partition matrix which indicates which/how much of a basis belongs to which source. Accordingly, the complexity parameter for each source is required to be specified in the first prior art and the parameter for common complexity of all sources is required to be specified in the second prior art. The partition function then appropriately allocates sufficient complexity to each source.

PTL 1 is applicable for applications like music separation, where only a few periodicities (frequencies) are estimated using sparsity constraints. In other words, PTL 1 discloses that only finds optimal periodicities in the mixture signals and assigns them to source signals. For example, PTL 1 discloses that separating piano periodicities/frequencies from drum periodicities/frequencies. However, PTL 1 does not disclose “calculating reconstructed mixed frequency data based on the number of sources of the plurality of data, a predetermined mixing matrix, a basis matrix, a reliability of the basis matrix, and an activation matrix, calculating a difference between the mixed frequency data and the reconstructed mixed frequency data, estimating a plurality of frequency data based on the reconstructed mixed frequency data when the difference is less than a predetermined difference threshold value,”.

### CITATION LIST

### Patent Literature

PTL 1: Japan application publication number, JP2017134284 (A)

### Non Patent Literature

NPL 1 and NPL 2 are the same literature document but contain two different methods.
NPL 1: Kitamura, Daichi, et al. “Determined blind source separation unifying independent vector analysis and nonnegative matrix factorization.” IEEE/ACM Transactions on Audio, Speech and Language Processing (2016).
NPL 2: Kitamura, Daichi, et al. “Determined blind source separation unifying independent vector analysis and nonnegative matrix factorization.” IEEE/ACM Transactions on Audio, Speech and Language Processing (2016).
NPL 3: Itakura, Kousuke, et al. “Bayesian multichannel nonnegative matrix factorization for audio source separation and localization.” Acoustics, Speech and Signal Processing (ICASSP), 2017 IEEE International Conference on. IEEE, 2017.

### SUMMARY OF INVENTION

### Technical Problem

As discussed in description of background arts, while modelling the sources a complexity parameter must be specified by the user. In NPL 1, complexity is given for each source. The fundamental problem in the formulation of this method is that the user may not be aware of the complexity needed for each individual source. For example, a typical phone beep will have a small complexity while a typical human speech will have a higher complexity than the phone beep and a typical song with vocals, drums, piano etc. will have a much higher complexity than human speech. A user barely aware or unaware of the nature of the audio sources can only specify an approximate value for the complexity of each source. This can lead to over-fitting or under-fitting when modelling each source.

The second prior art NPL 2 attempts to partially overcome the user awareness problem by using a partition matrix. In NPL 2, the combined complexity of all sources is specified by the user. For example, consider the case where all the sources are of low complexity like phone beeps, then overall complexity is lower compared to the case where some sources are phone beeps and the remaining are human speech, which also has a lower complexity compared to the case where all the sources are human speech. In this example, it is considered that there are equal numbers of sources in each case. So a user must still be aware of the combined complexity. Later the partition matrix appropriately allocates a sufficient number of basis vectors to model a particular source. Although the number of complexity parameters needed to be specified is lowered to one as compared to NPL 1, the user must still specify a combined complexity parameter. The present invention attempts to solve this source(s) complexity problem in both NPL 1 and NPL 2.

A purpose of the present disclosure is to provide a source separation method, a non-transitory computer readable medium, and a source separation apparatus that solve any of the problems described above.

### Solution to Problem

According to one aspect of the present invention, there is provided a source separation device using matrix decomposition with a non-parametric estimation of source complexity comprising:

An input means for inputting mixture data obtained by mixing a plurality of data; and

a matrix decomposition means for calculating mixed frequency data obtained by converting the mixture data into a frequency domain,

iteratively decomposing the mixed frequency data based on the number of sources of the plurality of data, into a mixing/unmixing matrix, a basis matrix for each source, a reliability vector for each source, and an activation matrix for each source, until convergence is reached,

estimating a plurality of frequency data after reaching convergence and

converting each of the plurality of estimated frequency data into a time domain to calculate a plurality of estimated data.

According to one aspect of the present invention, there is provided a method for a source separation device using matrix decomposition with a non-parametric estimation of source complexity comprising:

inputting mixture data obtained by mixing a plurality of data;

calculating mixed frequency data obtained by converting the mixture data into a frequency domain;

iteratively decomposing the mixed frequency data based on the number of sources of the plurality of data, into a mixing/unmixing matrix, a basis matrix for each source, a reliability vector for each source, and an activation matrix for each source, until convergence is reached;

estimating a plurality of frequency data after reaching convergence; and

converting each of the plurality of estimated frequency data into a time domain to calculate a plurality of estimated data.

According to one aspect of the present invention, there is provided a non-transitory computer readable medium storing a program causing a source separation device to execute:

inputting mixture data obtained by mixing a plurality of data;

calculating mixed frequency data obtained by converting the mixture data into a frequency domain;

iteratively decomposing the mixed frequency data based on the number of sources of the plurality of data, into a mixing/unmixing matrix, a basis matrix for each source, a reliability vector for each source, and an activation matrix for each source, until convergence is reached;

estimating a plurality of frequency data after reaching convergence; and

converting each of the plurality of estimated frequency data into a time domain to calculate a plurality of estimated data.

### Advantages of Invention

According to the present disclosure, it is possible to provide a source separation method, a non-transitory computer readable medium, and a source separation apparatus using matrix decomposition with non-parametric estimation of source complexity.

The technical problem presented above only occurs in the source modelling part of the above prior arts. So, the present invention aims to solve the technical problem of specifying source(s) complexity mentioned above, in relation to the Matrix Decomposition based source separation. It is summarized below into two embodiments. For the first embodiment, the present invention proposes a non-parametric method for estimating the complexity of each of the sources by extending the method proposed in NPL 1 which decomposes the microphone signal data into 3 parts (mixing/unmixing matrix, basis matrix of sources, activations matrix of sources). For the second embodiment, the present invention proposes a non-parametric method for estimating the combined complexity of all sources by extending the method proposed in NPL 2 which decomposes the microphone signal data into 4 parts (mixing/unmixing matrix, partition matrix, basis matrix of sources, activations matrix of sources).

By solving the problem of user's awareness to the complexity of sources, the present invention is no longer constrained to have an additional complexity parameter. The present invention solves this problem by estimating the complexity of each source in the first embodiment and estimating the combined complexity of all sources in the second embodiment. The advantage of the present invention is that it is now flexible in being used to separate all type of sources with unknown complexity. In the example of separating phone beeps from human speech, the present invention can therefore estimate the complexity of phone beeps and human speech whilst simultaneously separating both of these sources from their mixture signals. In other words, the present invention can solve the problem of multi-source complexity estimation during source separation.

### BRIEF DESCRIPTION OF DRAWINGS

All the Figs together with the embodiments explain the principles of the present invention. Note that the Figs are an illustration of the present invention and do not limit its scope.

FIG. 1 is a typical framework for audio source separation with at least two source signals, whose mixture signals are captured by surrounding microphones.

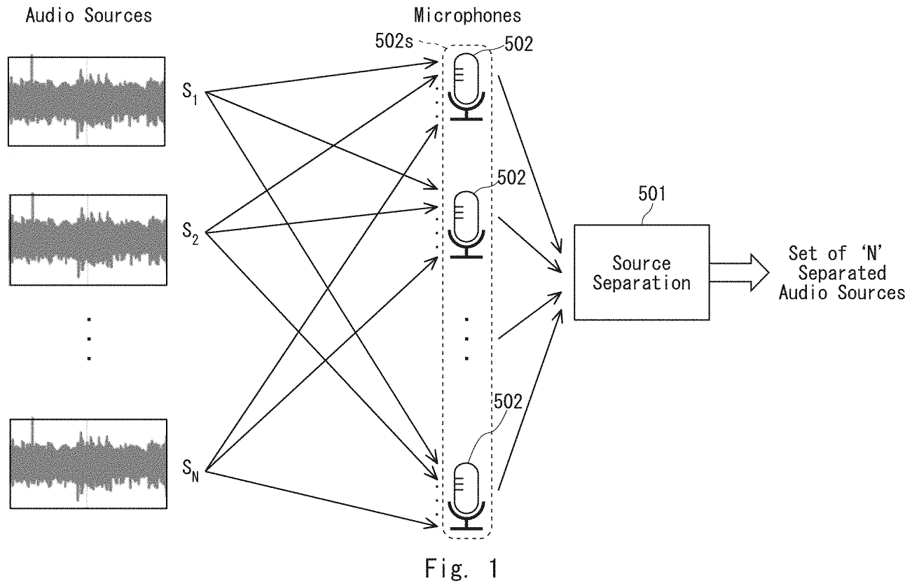

FIG. 2A is a block diagram that illustrates an example of the first embodiment of the present invention.

FIG. 2B is a block diagram that illustrates an example of the matrix decomposition block in the first embodiment of the present invention.

FIG. 3A is a block diagram that illustrates an example of the second embodiment of the present invention.

FIG. 3B is a block diagram that illustrates an example of the matrix decomposition block in the second embodiment of the present invention.

FIG. 4 is a flow chart of the procedure of an example of the first embodiment of the present invention.

FIG. 5 is a flow chart of the procedure of an example of the second embodiment of the present invention.

FIG. 6 is a block diagram that illustrates the method described in prior art NPL 1.

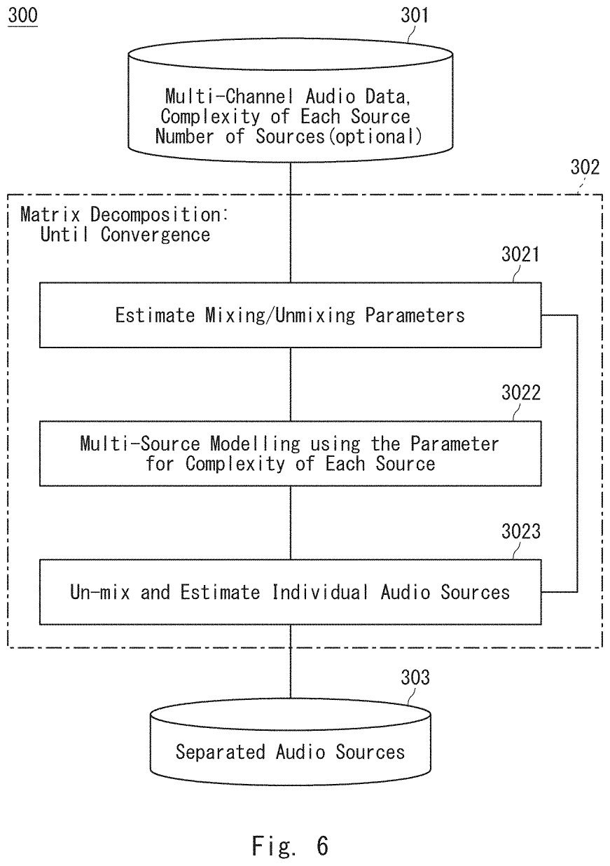

FIG. 7 is a block diagram that illustrates the method described in prior art NPL 2.

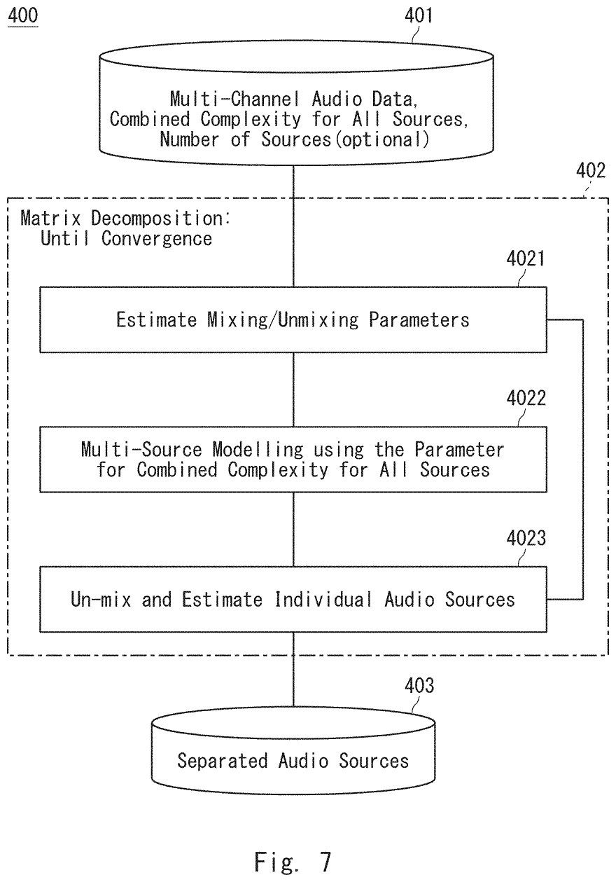

FIG. 8A shows a Matrix Decomposition of an example 7 seconds Piano Roll into Bases and Activations.

FIG. 8B shows a Matrix Decomposition of an example 7 seconds Piano Roll into Bases and Activations.

FIG. 8C shows a Matrix Decomposition of an example 7 seconds Piano Roll into Bases and Activations.

### DESCRIPTION OF EMBODIMENTS

Optimization techniques based on matrix factorizations are the core of source separation algorithms, used to separate individual sources from their mixture signals. These algorithms are mainly comprised of two important blocks—estimation of mixing parameters and modelling of source parameters. In NPL 1, the algorithm uses Non-Negative Matrix Factorization (NMF) to model the source parameters using two parts: basis matrices for each source and activation matrices for each source. In NPL 2, the algorithm uses NMF to model the source parameters using three parts: partition matrix, common basis matrix of all sources, common activations matrix of all sources. As discussed earlier, the problem with these methods is that the user must specify an estimate of the source(s) complexity in order to efficiently model the source parameters.

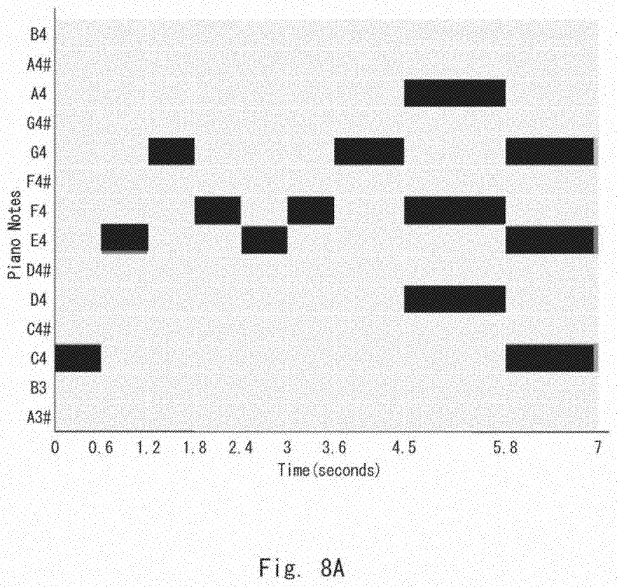

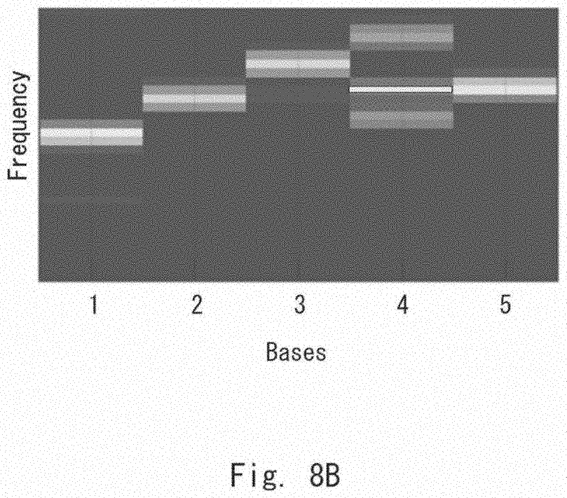

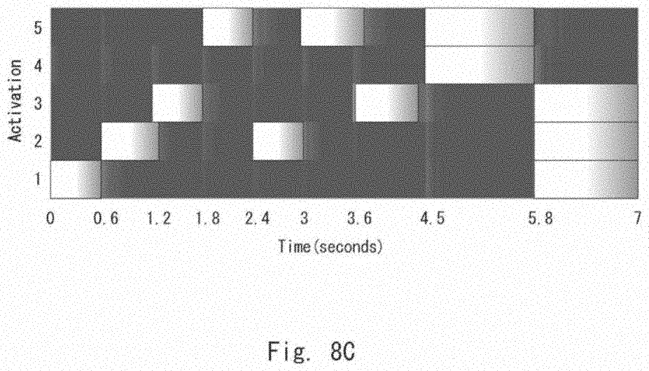

To understand this problem, we first look at a brief introduction to NMF as dimensionality reduction technique that allows us to efficiently model a huge amount of data (stored as a matrix) using two or more smaller amounts of data (stored as matrices). The main reason for using this technique is to model the correlations present in a large amount of data. In the applications of series data, it is generally observed that the data features are highly correlated. Especially while doing audio processing and image processing, the feature vectors extracted from the series data can be approximately modelled as a linear combination of a few basis vectors. Matrix decomposition is a set of techniques for estimating such basis vectors. The example presented in FIG. 8A, FIG. 8B, and FIG. 8C illustrate visually the Matrix Decomposition technique, used to find the correlations in a 7 seconds Piano Roll. Each highlighted block represents a piano note played during the block's time interval i.e. the note C4 is played during the first 0.6 s, the notes D4, F4 and A4 are played during the time interval 4.5 s to 5.8 s etc. After its Matrix Decomposition, it can be observed that there are only 5 basis sounds which actually constitute the overall Piano Roll. These are depicted as columns in Bases of FIG. 8B. Each row depicted in the Activations of FIG. 8C shows the time interval in which each of the basis has occurred i.e. basis #1 occurred during the first 0.6 s, basis #4 and #5 occurred together during 4.5 s to 5.8 s, basis #1, #2 and #3 occurred together during the final 1.2 s. This example attempts to illustrate correlations generally present in audio processing. However, such correlations occur in most of series data.

Matrix Decomposition estimates such correlations present in the series data when represented as a feature matrix (a set of feature vectors). Define the feature matrix (X) as a set of J feature vectors

{x̅ⱼ}, where 1≤j≤J.

The decomposition of the feature vectors is:

x̅ⱼ≈b̅₁h₁ⱼ+b̅₂h₂ⱼ+ . . . +b̅_{K}h_{Kj},

where each vector

x̅ⱼ

is approximated as a linear combination of the basis vectors

{b̅ₖ, 1≤k≤K}.

Generally k<<N, which means that only a few basis vectors are sufficient to estimate the feature matrix X. The set of basis vectors is the Basis Matrix (B) and

H={hₖⱼ},

1≤k≤K, 1≤j≤J

is set of activations or the Activation Matrix. More concisely,

X≅BH.

For estimating the decomposition of X, a cost function, which is a similarity measure between X and BH is often minimized. This implies that the cost function treats the cost function minimization of each feature vector with equal priority. When elements of the feature matrix are all positive, then Non-Negative Matrix Factorization (NMF) is one of the techniques used to find the decompositions such that all the elements of B and H are positive.

NMF is discussed because of its efficiency in extracting few basis vectors (B) that are sufficient to model our feature matrix (X). Note that in the earlier Piano example illustration of FIG. 8A to FIG. 8C, 5 basis vectors are extracted because there are 5 unique features inside the feature matrix. If we extract fewer or larger than 5 basis vectors, then it leads to under-estimation or over-estimation respectively. Therefore in this case, number of basis=5 is termed as the complexity of given Piano Roll. This indicates the importance of knowing the complexity of a source (Piano Roll) when modelling with Matrix Factorization methods.

In the context of source separation, several sources (time-series data like Piano Roll) are recorded simultaneously. In the case of audio source separation, mixtures of audio source signals are recorded using two or more microphones. Therefore in the source separation algorithms, a mixing/unmixing matrix (W) is estimated which contains information about how the original sources are mixed to obtain the mixture data. Then the sources are efficiently modelled using matrix factorization methods as discussed earlier.

Prior art NPL 1 therefore decomposes the feature matrix (X) of the mixture signals into a mixing/unmixing matrix (W) and source matrices ({Sₙ},

1≤n≤N

and N is the total number of sources), where each source matrix (Sₙ) is further modelled as a product of that source's basis matrix (Bₙ) and activations matrix (Hₙ). As discussed earlier, the modelling of each source is effected by the complexity specified for that source.

To avoid the problem of a user specifying an estimate of the complexity of each source, our first embodiment also models each source matrix (Sₙ) using matrix factorization but using a large number of basis vectors and introduces a reliability vector to estimate the reliability of each of these basis vectors. Therefore the complexity of each source is estimated simultaneously without the need to specify complexity parameter, while also unmixing the sources from their mixture signals.

In other words, we propose a multi-source modelling with non-parametric complexity estimation of each source while also estimating the mixing parameters.

Prior art NPL 2 decomposes the feature matrix (X) of the mixture signals into a mixing/unmixing matrix (W), partition matrix (Z), common basis matrix (B) and a common activations matrix (H). Here the partition matrix (Z) tells which/how much of a particular basis is allocated to a particular source. Recall that, as mentioned above, the total contribution of each basis must be 100%. And similar to NPL 1, discussed earlier, the combined modelling of sources is effected by the combined complexity specified for modelling all the sources.

To avoid the problem of a user specifying an estimate of the combined complexity of all sources, our second embodiment also models all the sources together using a partition matrix (Z) and common basis matrix (B) and activations matrix (H) but treats Z as a set of reliability vectors for partitioning the basis matrix B. This is done by modelling all the sources together using a large number of basis vectors and removing the requirement that the total contribution of each basis has to be 100%. So Z defines the contribution of each basis to each source and the total contribution of a particular basis defines the reliability of that basis and the total contribution received by a source defines the source's complexity. Therefore the user need not specify the combined complexity parameter to model the sources. In other words, we propose a multi-source modelling with non-parametric combined complexity estimation of all sources.

To summarize, the first and second embodiments of the present invention improve the existing source separation algorithms. They overcome the requirement of a user to specify an estimate of both complexity of each source to be separated and the combined complexity of all sources to be separated.

From here on, the sections will describe the two embodiments of the present invention in detail. They are explained so that the differences and their advantages over the prior arts are clear and a person skilled in the art can use this description along with the illustrative Figs and be able to implement the invention.

### First Embodiment

<Source Separation Device>

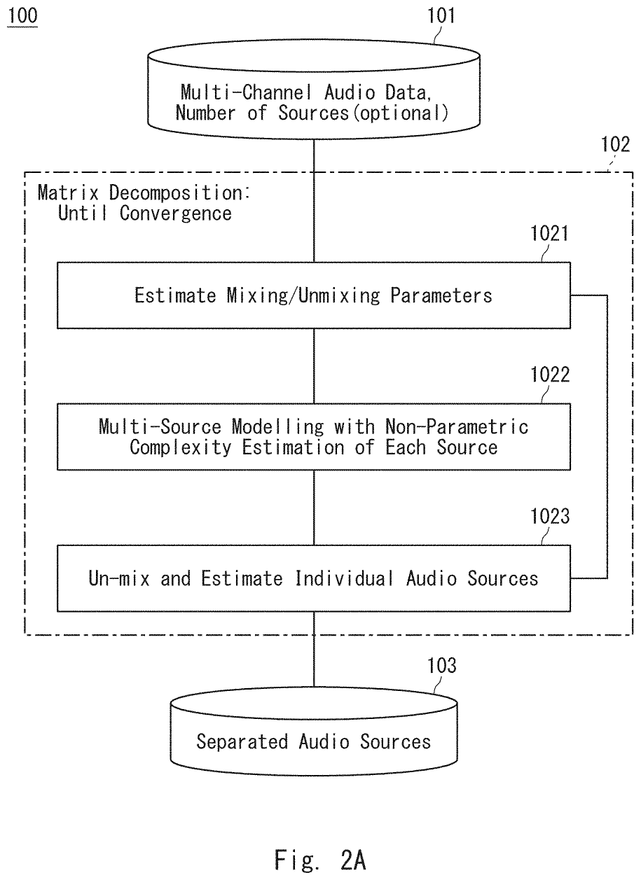

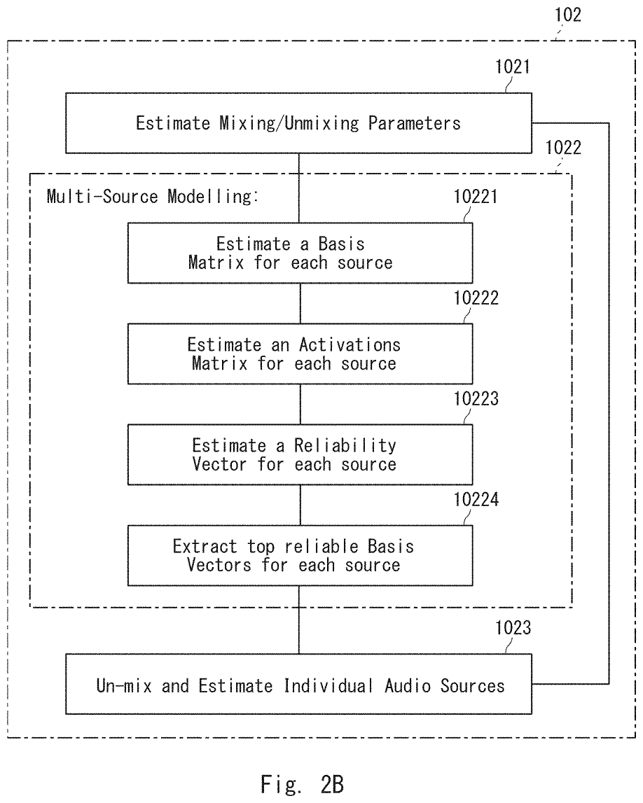

The first embodiment of the present invention solves the problem of parametric modelling of multiple sources during source separation. The block diagram in FIG. 2A and FIG. 2B illustrate the first embodiment of present invention by showing the configuration of the source separation device 100. The source separation device 100 includes a Mixture Data Input block 101, a Matrix Decomposition block 102 and a Separated Data Output block 103. The mixture data input block is called an input unit, the matrix decomposition block is called a matrix decomposition unit, and the separated data output block is called an output unit. Block diagram in FIG. 2A and FIG. 2B only illustrates the present invention and does not limit its scope.

The Mixture Data Input block 101 contains the multi-channel audio data used as input. Since multi-channel audio data is data in which a plurality of data is mixed, it may be called mixture data. This multi-channel data is either the raw audio data or a transformed version of raw audio data. This transformation is generally a spectrogram of raw multi-channel audio data used as a feature matrix from which sources have to be separated. The spectrogram is mixture frequency data obtained by converting mixed data into a frequency domain. So the Mixture Data Input block 101 contains multi-channel data points. The Mixture Data Input block 101 data may be obtained from any means of quantitative data collection. For example, however not limited to, sound sensors, vibration sensors, automobile related sensors, chemical sensors, electric sensors, magnetic sensors, radiation sensors, pressure sensors, thermal sensors, optical sensors, navigational sensors and weather sensors. However, the data input can also be features obtained by transforming the data obtained from sensors like the ones listed above. For example, however not limited to, Mel-Frequency Cepstral Coefficients and Spectrogram for audio data, intensity and texture for images. We also note that an optional input of number of sources (that were mixed or to be separated) can also be specified as part of the Mixture Data Input block 101.

The Matrix Decomposition block 102 obtains the data from the Mixture Data Input block 101 and performs an optimization until convergence to estimate the mixing parameters and the unmixed source parameters. The Matrix Decomposition block 102 is an optimization block containing an Estimate Mixing/Unmixing Parameters block 1021, a Multi-Source Modelling with Non-Parametric Complexity Estimation of Each Source block 1022 and a Un-mix and Estimate Individual Sources block 1023.

As the name indicates, the Estimate Mixing/Unmixing Parameters block 1021 iteratively estimates the mixing parameters that mixed the source signals to result the mixture signals. As the Matrix Decomposition block 102 iteratively reaches convergence, the Estimate Mixing/Unmixing Parameters block 1021 efficiently estimates the mixing parameters. They can be estimated using, however not limited to, direction of arrival estimation methods based on the phase spectrum of audio signals.

The Multi-Source Modelling with Non-Parametric Complexity Estimation of Each Source block 1022 also iteratively models all the sources that were mixed to result in mixture signals. As the Matrix Decomposition block 102 iteratively reaches convergence, the Multi-Source Modelling with Non-Parametric Complexity Estimation of Each Source block 1022 efficiently models all the sources even when an estimate of each source's complexity is not specified by the user. As discussed earlier in the Piano Roll example, this modelling can done using, however not limited to, non-parametric extensions of matrix factorization methods like Principal Component Analysis (PCA), Eigen value decomposition Graph-based kernel PCA, Independent Component Analysis, Non-Negative Matrix Factorization, and Singular value decomposition, Linear Discriminant Analysis, Generalized Discriminant Analysis. An illustration of the block 1022 as shown in FIG. 2B comprises of Estimate a Basis Matrix for Each Source block 10221, Estimate an Activations Matrix for Each Source block 10222, Estimate a Reliability Vector for Each Source block 10223 and Extract Top Reliable Basis Vectors for Each Source block 10224. The size of the reliability vector of a particular source is same as the number of basis vectors in the basis matrix estimated for that particular source. Each element in a source's reliability vector represents the contribution of a corresponding basis vector in modelling said source. Therefore higher the contribution of a basis vector, higher its reliability. The Extract Top Reliable Basis Vectors for Each Source block 10224 is an optional block which increases the computational efficiency of the source separation device. This is because it extracts the top reliable basis vectors, or in other words ignores the low reliable basis vectors. The low reliable basis vectors of a source, by definition contribute less to that source's modelling. Hence they will not have much effect on the source's modelling even if they are not ignored. We also note that the blocks 10221 until 10224 need not be executed in the specified order which is (10221->10222->10223->10224). Their operation can be interchanged among themselves and FIG. 2B is only one possible illustration of matrix decomposition block 102.

Again as the names indicates, the Un-Mix and Estimate Individual Sources block 1023 unmixes the mixture signals using the estimated mixing parameters (strengthened by the multi-source modelling with non-parametric complexity estimation of each source). After unmixing, the Un-Mix and Estimate Individual Sources block 1023 is able to estimate the individual sources. As the Matrix Decomposition block 102 iteratively reaches convergence and efficiently estimates the mixing parameters, the Un-Mix and Estimate Individual Sources block 1023 unmixes the mixture signals to obtain an optimum estimate of individual sources. This unmixing can be done by, however not limited to, solving linear matrix equations.

Once the convergence in block Matrix Decomposition 102 is reached, the estimated individual sources are outputted into the Separated Data Output block 103. Depending on the nature of original Data Input block 101, the separated sources are either in the form of raw data or as transformed features. Accordingly, the output cans the reverse-transformed features to get back the raw data. This can be done by, however not limited to, estimating raw audio from spectrograms, mel-frequency cepstral coefficients in audio data, estimating raw images from texture, intensity features in image data.

<Operation of Source Separation Device>

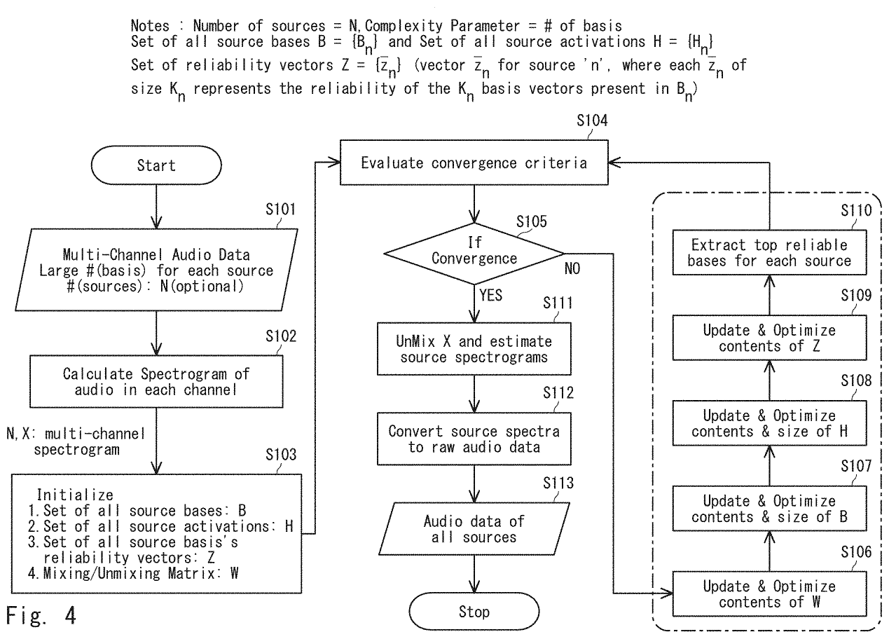

The operation of the first embodiment is detailed in the flow chart shown in FIG. 4. This flow chart is an illustration of an application of the first embodiment for series data inputs. In this illustration, the algorithm separates N sources from the multi-channel mixture data. The definition of complexity of a source is the number of basis vectors used to model said source.

When the process flow of source separation of the first embodiments starts, it receives multi-channel audio data in the input step S101. The step S101 also contains information about the number of sources N, and a large number of basis vectors to model each source. When modelling the source n,

1≤n≤N,

let this large number be denoted as Kₙ. Among these large number of basis vectors, a few will be appropriately selected and optimized to model the complexity of each source.

Step S102 is a feature extraction step that calculates the spectrogram of the mixture audio present in each channel. The calculated multi-channel spectrogram is represented as X. If we are given M (>1) channels of mixture data, then the spectrogram of each channel (Xₘ) will be an I×J matrix where J number of feature vectors are extracted and each feature vector has a size I. In total, the multi-channel spectrogram is an I×J×M matrix containing complex numbers as elements (spectrogram is complex-valued).

Step S103 initializes the mixing parameters and the source modelling parameters. The mixing parameters are represented in a matrix W of size I×N×M. If W is the mixing matrix, then a corresponding unmixing matrix can be estimated from W. For simplicity the theory is being detailed in terms of mixing matrix, but it also can be generalized in terms of unmixing matrix. In W, each mixing vector of size I represents the way in which feature vectors (size I) of the n^{th} source transform when recorded by the m^{th} microphone. As discussed above, each source is modelled a product of a basis matrix and an activations matrix. There are N sources, so there are N basis matrices and N activation matrices. Set of source basis matrices is B={Bₙ},

1≤n≤N.

Similarly, the set of all source activations matrix is H={Hₙ},

1≤n≤N.

Basis matrix Bₙ is of size I×Kₙ and corresponding activations matrix Hₙ is of size Kₙ×J. Basis matrix of each source Bₙ contains Kₙ number of basis vectors. Because Kₙ is large, we introduce a reliability vector

z̅ₙ

of size Kₙ, where the Kₙ values in the vector

z̅ₙ

represent the reliability of the Kₙ basis vectors present in Bₙ. In total, the n^{th} source is modelled by scaling the basis vectors in Bₙ with their respective reliabilities from the vector

z̅ₙ

and then multiplying it with the activations Hₙ. Set of all source's reliability vectors are denoted as

Z={z̅ₙ}, 1≤n≤N.

The matrix decomposition of multi-channel feature data X is optimized in the loop indicated by steps S104 to S110 until convergence. Step 104 evaluates a convergence criteria appropriate for this optimization. An instance of such criteria is reconstruction error, which estimates the error ERR between X and reconstruction of X. This reconstruction is obtained by mixing each of the N sources being estimated as

(z̅ₙ∘Bₙ)Hₙ, 1≤n≤N

with the mixing matrix W. This reconstruction may also be called to as reconstructed mixed frequency data. The reconstructed mixed frequency data approximates the mixed frequency data. The reconstructed mixed frequency data is calculated based on the number of sources N of the plurality of data, a mixing matrix W, a basis matrix B, a reliability Z of the basis matrix B, and an activation matrix H. Here

∘

indicates the multiplication of each element of vector

z̅ₙ

with the entire corresponding basis vector in the matrix Bₙ. The product of

(z̅ₙ∘Bₙ)

and Hₙ is a multiplication of matrices and results in a matrix of size I×J. The reconstruction of Xₘ (m^{th} channel of X) is estimated mathematically as

Xₘ≅Σₙw̅_{m,n}∘[(z̅ₙ∘Bₙ)Hₙ].

Here,

w̅_{m,n}

is the mixing vector of size I between the m^{th} channel for the n^{th} source. The term

(z̅ₙ∘Bₙ)Hₙ

is a matrix (size I×J) i.e. J columns each of size I. Each of these J columns of size I are multiplied element wise with the mixing vector

w̅_{m,n}

of size I. The overall product

w̅_{m,n}∘[(z̅ₙ∘Bₙ)Hₙ]

represents the transformation of n^{th} source as recorded by the m^{th} channel. The sum of transformations of all N sources estimates the recorded data of the m^{th} channel i.e. Xₘ.

As is general with most reconstruction error based convergence checks, this source separation algorithm also checks if the reconstruction error ERR is less than a certain small value eps (epsilon). One possible way to evaluate ERR is by taking a sum of absolute difference between the corresponding elements of mixed frequency data and the reconstructed mixed frequency data. Other ways to evaluate ERR are, however not limited to, root mean square error and mean square error. Essentially a convergence check is similar to either minimizing/maximizing of some pre-defined cost function. For example, minimizing mean square error or maximizing the log-likelihood of our model. In NPL 1, the cost function (to be maximized) is obtained by assuming the source model parameters to be drawn from an isotropic Gaussian distribution. If the value of eps is difficult to specify (as in most cases), an alternative is to perform optimization for a satisfactory number of loops. This check is performed by Step S105. If check is not successful, then the optimization continues for another iteration, and when successful it exits the optimization loop.

When convergence is not reached, step S105 leads to steps S106 until S110. Note that the steps S106 to S110 need not be in any particular order as they are update steps of parameters W, Z, B and H.

Step S106 updates and optimizes the content of the mixing matrix W.

Step S107 updates and optimizes both contents and sizes of each source's basis matrices {Bₙ}. Similarly, step S108 updates and optimizes both the contents and sizes of each source's basis matrices {Hₙ}. Because we start with a large number of basis vectors {Kₙ} for the N sources, we gradually reduce the number of basis vectors for each source until the complexity of that source is reached.

Step S109 updates and optimizes the contents of each source's reliability vectors Z. Step S110 extracts the top values of each source's reliability vector. This can be done using, however not limited to, thresholding by identifying the values that are very less reliable or simply identifying the least reliable value. The number of top reliable values in a source's reliability vector determines its updated complexity as estimated for that iteration. The low reliable values indicated the low reliable basis vectors can be ignored from future iterations. This is the size update of {Bₙ}, as explained above in step S107. We optimize each of the mixing matrix, the basis matrix, the reliability and the activation matrix in each iteration, and repeat the optimization until the reconstruction error is less than the predetermined difference threshold value. When the iterative optimization is stopped, convergence is reached.

After iteratively optimizing the parameters W, Z, B and H until convergence is reached, we move from the step S105 to step S111. In step S111, the multi-channel spectrogram X is unmixed using the mixing matrix estimated during the optimization and estimates each of the N individual source spectrograms. That is, when the convergence is reached (Step 105: Y), a plurality of frequency data are estimated based on the reconstructed mixed frequency data.

Step S112 converts the N estimated source spectrograms back to N raw audio signals. That is, in step 112, each of the plurality of estimated frequency data is converted into a time domain to calculate a plurality of estimated data. This is done by, however not limited to, performing an inverse of the transformation done in step S102. And finally the N estimated audio sources are outputted into the step S113 and the process flow stops.

<Simple Case of Source Separation Device>

So far, we have detailed the block diagram of the first embodiment using an illustration of a process flow of the source separation algorithm as proposed by the present invention. Henceforth, we further attempt to illustrate the optimization steps S106 to S110 of the process flow shown in FIG. 4. This is done by detailing an application of the present invention that can be understood by a person fairly familiar with this topic. This application illustrates an improvement of the source separation method detailed in prior art NPL 1 using the present invention.

NPL 1 illustrates a scenario of separating M sources from M given mixture signals i.e. M=N. It decomposes X into an unmixing matrix and models the sources using a set of non-negative basis and activation matrices. Therefore the initialization step S103 initializes the each of basis and activation matrices using non-negative random values between 0 and 1. NPL 1 estimates unmixing parameters instead of mixing parameters due its ease of computation. It initializes the unmixing matrix W of size I×M×M as {Wᵢ=Identity matrix of size M×M, 1≤i≤I}.

All the steps except for S106 until S110 are fairly well known and/or detailed in literature. So we detail the improvements from steps S106 until S110.

Step S106 updates and optimizes contents of W using the equations already derived in literature NPL 4: ‘Ono, Nobutaka. “Stable and fast update rules for independent vector analysis based on auxiliary function technique.” Applications of Signal Processing to Audio and Acoustics (WASPAA), 2011 IEEE Workshop on. IEEE, 2011’.

These update equations for each vector

{w̅_{i,m}, 1≤i≤I, 1≤m≤M}

of size M×1 and described below as

$${V}_{i , m} = \frac{1}{J} {\sum }_{j} \frac{1}{{r}_{ij , m}} {\overline{x}}_{ij} {{\overline{x}}^{h}}_{ij} , \\ {\overline{w}}_{i , m} = {( {W}_{i} {V}_{i , m} )}^{- 1} {\overline{e}}_{m} , \\ {\overline{w}}_{i , m} = {{\overline{w}}_{i , m} ( {{\overline{w}}^{h}}_{i , m} {V}_{i , m} {\overline{w}}_{i , m} )}^{- 1 / 2} .$$

Here, r_{ij,m} is the estimated variance of the m^{th} source, (.)^{h} denotes its hermitian,

ēₘ

is a unit vector with m^{th} element equal to 1 and rest as 0. The prior art NPL 1 models r_{ij,m} as

r_{ij,m}=Σₖb_{ik,m}h_{kj,m},

Here b_{jk,m} are the elements of the basis matrix of the m^{th} source Bₘ where

k, 1≤k≤Kₘ

indicates the basis number and the k^{th} basis vector

b̅ₖ={bᵢₖ}, 1≤i≤I.

Similarly, h_{kj,m} are the elements of the activations matrix of the m^{th} source Hₘ, where the k^{th} activation vector

h̅ₖ={hₖⱼ}, 1≤j≤J.

The cost function Q that is maximized during this optimization is

$$Q = {\sum }_{i} {\sum }_{j} [ - 2 log ( det ( {W}_{i} ) ) + {\sum }_{m} \frac{{( {{\overline{w}}^{h}}_{i , m} {\overline{x}}_{ij} )}^{2}}{{r}_{ij , m}} + {\sum }_{m} log ( {r}_{ij , m} ) ] .$$

The method in the first embodiment of the present invention instead models r_{ij,m} as

r_{ij,m}=Σₖz_{k,m}b_{ik,m}h_{kj,m},

where z_{k,m} is the reliability of the k^{th} basis vector of the m^{th} source. The reliability vector

z̅ₘ

of m^{th} source is nothing but

z̅ₘ={z_{k,m}}, 1≤k≤Kₘ.

An approach is, however not limited to, to start with a large value for Kₘ and gradually identify the most reliable basis vectors for each source and ignore the less reliable basis. The basis vectors in each basis matrix whose reliability is equal to or higher than the predetermined reliability is extracted.

To do optimization of B, H and Z as described in steps S107, S108 and S109, we can use, however not limited to, variational inference techniques. In such inference techniques, the m^{th} source parameters i.e.

z̅ₘ,

Bₘ and Hₘ can be modelled from gamma processes as

distribution of b_{ik,m}˜Gamma(a₀,a₀),

distribution of h_{kj,m}˜Gamma(b₀,b₀),

distribution of z_{k,m}˜Gamma(c₀,cₘ),

where a₀, b₀ and c₀ are some positive constants (which do not have much effect on the overall source modelling) and finally

cₘ=c₀(IJK)[ΣᵢΣⱼ(w̅^{h}_{i,m}x̅ᵢⱼ)²]⁻¹.

In this variational inference application, each of the source distributions are inferred from a conditional distribution (cond. distr.) on a family of Generalized Inverse-Gaussian (GIG) distributions by estimating appropriate their hyper parameters as

cond. distr. b_{ik,m}˜GIG(a₀,ρ_{ik,m}^{B},τ_{ik,m}^{B}),

cond. distr. h_{kj,m}˜GIG(b₀,ρ_{kj,m}^{H},τ_{kj,m}^{H}),

cond. distr. of z_{k,m}˜GIG(c₀,ρ_{k,m}^{Z},τ_{k,m}^{Z}),

where the tuples

(τ^{B},τ^{B}), (ρ^{H},τ^{H}) and (ρ^{Z},τ^{Z})

are the hyper parameters of each of source's Basis matrix, Activations matrix and Reliability vector respectively. Values of z_{k,m}, b_{ik,m} and h_{kj,m} are estimated from the mean of their respective family of GIG conditional distributions. Using this formulation, one can derive the update rules of each of the hyper parameters by maximizing the cost function Q.

We skip the derivation here and give the update rules of each of hyper parameter as

$${ρ}_{ik , m}^{B} = {a}_{0} + {z}_{k , m} {Σ}_{j} \frac{{h}_{kj , m}}{{Σ}_{k} {z}_{k , m} {b}_{ik , m} {h}_{kj , m}} , \\ {τ}_{ik , m}^{B} = {Σ}_{j} \frac{{( {{\overline{w}}^{h}}_{i , m} {\overline{x}}_{ij} )}^{2} {Φ}_{ijk , m}^{2}}{{z}_{k , m} {h}_{kj , m}} , \\ {ρ}_{kj , m}^{H} = {b}_{0} + {z}_{k , m} {Σ}_{i} \frac{{b}_{ik , m}}{{Σ}_{k} {z}_{k , m} {b}_{ik , m} {h}_{kj , m}} , \\ {τ}_{kj , m}^{H} = {Σ}_{i} \frac{{( {{\overline{w}}^{h}}_{i , m} {\overline{x}}_{ij} )}^{2} {Φ}_{ijk , m}^{2}}{{z}_{k , m} {b}_{ik , m}} , \\ {ρ}_{k , m}^{Z} = {c}_{m} + {Σ}_{i} {Σ}_{j} \frac{{b}_{ik , m} {h}_{kj , m}}{{Σ}_{k} {z}_{k , m} {b}_{ik , m} {h}_{kj , m}} , \\ {τ}_{k , m}^{Z} = {Σ}_{i} {Σ}_{j} \frac{{( {{\overline{w}}^{h}}_{i , m} {\overline{x}}_{ij} )}^{2} {Φ}_{ijk , m}^{2}}{{b}_{ik , m} {h}_{kj , m}} ,$$

and the parameter

Φ_{ijk,m}

is defined as

$${Φ}_{ijk , m} = \frac{{( {z}_{k , m} {b}_{ik , m} {h}_{kj , m} )}^{- 1}}{{\sum }_{k} {( {z}_{k , m} {b}_{i k , m} {h}_{k j , m} )}^{- 1}} .$$

Finally the step S110 is where thresholding of reliability values if done for each source's reliability vector. Gradually over a sufficient number of iterations, convergence of the optimization is reached and complexity of each source is efficiently modelled by their respective reliability vectors. Note that less reliable basis vectors have less contribution in modelling their source. Therefore the thresholding or identifying top reliable values is only done so that less reliable basis vectors can be ignored and thereby improve our computational efficiency.

The steps proposed in the first embodiment of the present invention therefore successfully solve the problem of users having to specify an estimate of each of the source's complexity.

### Second Embodiment

<Source Separation Device>

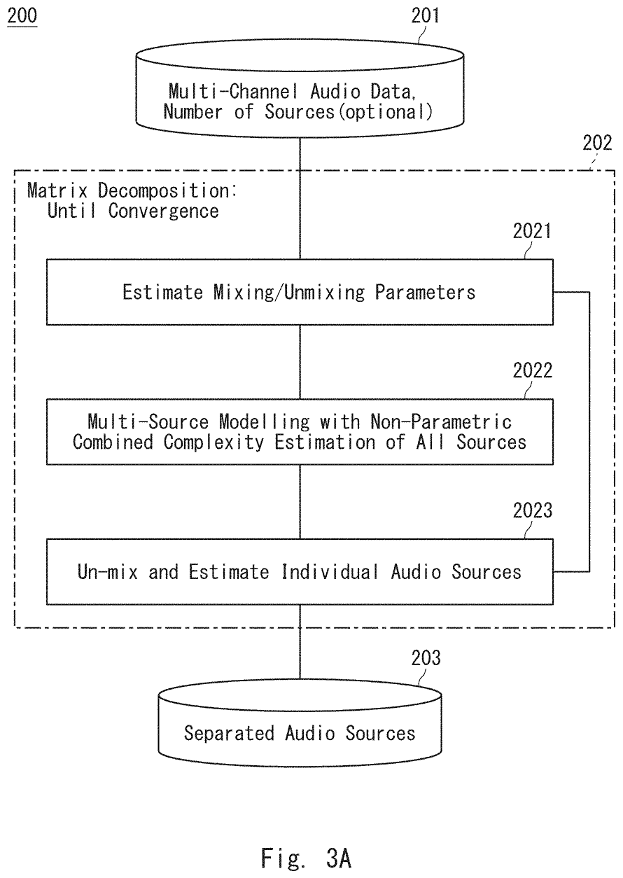

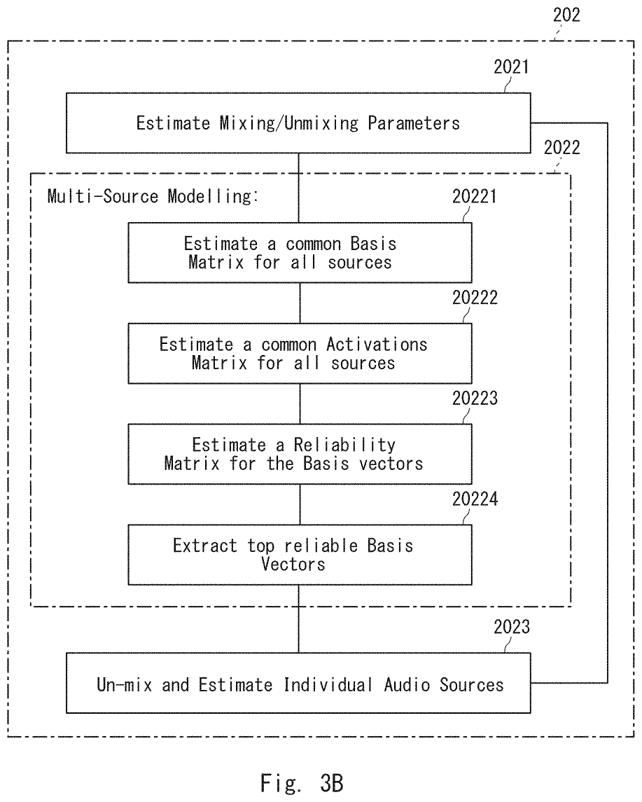

Although the source separation method detailed in the first embodiment overcomes the user having to specify an estimate of each source's complexity, modelling each source separately requires an estimation of parameters of each source. In other words, it requires an efficient estimation of many variables which can lead to local minima. To avoid this, the second embodiment extends the concept detailed in the first embodiment of the present invention by using a combined modelling all the sources and estimate the combined complexity of the sources. This non-parametric estimation of combined complexity of sources is also an extension of the method detailed as part of NPL 2. Block diagram of the second embodiment is illustrated in FIG. 3A and FIG. 3B, and extends the first embodiment by replacing the “Multi-Source Modelling with Non-Parametric Complexity Estimation of Each Source” block 1022 with the “Multi-Source Modelling with Non-Parametric Combined Complexity Estimation of all Sources” block 2022.

The source separation device 200 includes a Mixture Data Input block 201 and a Separated Data Output block 203 which have the same functionality as the Mixture Data Input block 101 and Separated Data Output block 103 respectively. Device 200 also has a Matrix Decomposition block 202 which contains an Estimate Mixing/Unmixing Parameters block 2021 and a Un-mix and Estimate Individual Sources block 2023 which have the same functionality as the Estimate Mixing/Unmixing Parameters block 1021, the Un-mix and Estimate Individual Sources block 1023 respectively.

The Multi-Source Modelling with Non-Parametric Combined Complexity Estimation of all Sources block 2022 also iteratively models all the sources that were mixed to result in mixture signals and is part of the Matrix Decomposition block 202. As the block 202 iteratively reaches convergence, block 2022 efficiently models all the sources even when an estimate of each source's complexity is not specified by the user. As discussed earlier in the Piano Roll example, this modelling can done using, however not limited to, non-parametric extensions of matrix factorization methods like Principal Component Analysis (PCA), Eigen value decomposition Graph-based kernel PCA, Independent Component Analysis, Non-Negative Matrix Factorization, and Singular value decomposition, Linear Discriminant Analysis, Generalized Discriminant Analysis. The block 2022 differs from the block 1022 in the way it operates while performing multi-source modelling. An illustration of the block 2022 as shown in FIG. 3B comprises of Estimate a Common Basis Matrix for All Sources block 20221, Estimate a Common Activations Matrix for All Sources block 20222, Estimate a Reliability Matrix for the Basis Vectors block 20223 and Extract Top Reliable Basis Vectors block 20224. The reliability matrix in block 20223 is a set of reliability vectors, where a reliability vector corresponding to a particular source can be interpreted similarly to the reliability vector defined in the first embodiment. So, there are as many reliability vectors as there are number of sources. The size of the reliability vector of a particular source is same as the number of basis vectors in the common basis matrix. Each element in a source's reliability vector represents the contribution of a corresponding basis vector in modelling said source. The overall contribution of a basis vector will be the sum of its contributions to each source. Therefore, higher the overall contribution of a basis vector, higher is its reliability. The Extract Top Reliable Basis Vectors block 20224 is an optional block similar to block 10224 of the first embodiment, which increases the computational efficiency of the source separation device.

<Operation of Source Separation Device>

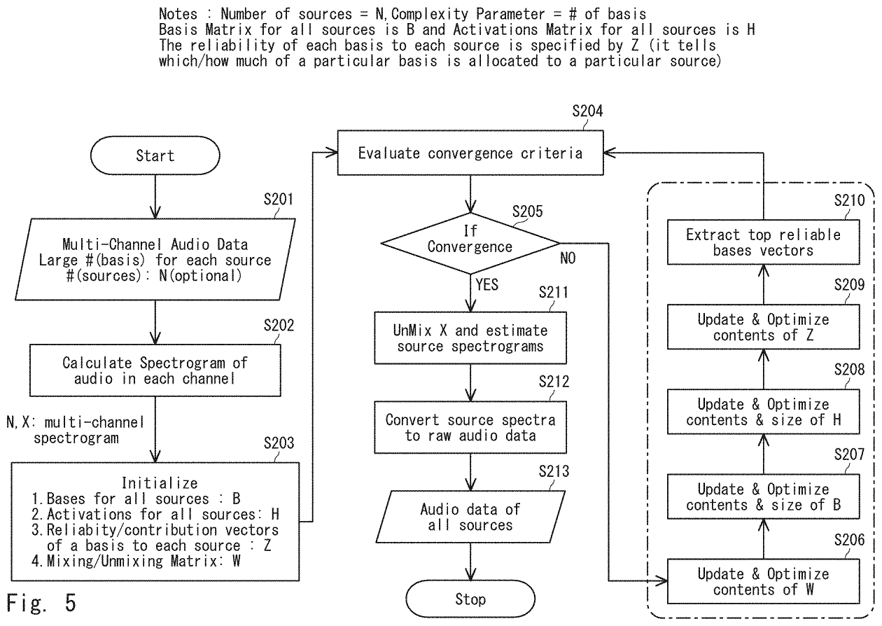

The operation of the second embodiment is detailed in the flow chart shown in FIG. 5. This flow chart is an illustration of an application of the second embodiment for series data inputs. The block diagram in FIG. 3A and FIG. 3B is only an illustration of the present invention and do not limit its scope.

When the process flow of source separation of the second embodiments starts, it receives multi-channel audio data in the input step S201. The step S201 also contains information about the number of sources N, and a large number of basis vectors that together model all the sources. Let this large number be denoted as K. Among these large number of basis vectors, a few will be appropriately selected and optimized to model the complexity of each source.

Step S202 is a feature extraction step that calculates the multi-channel spectrogram as X. Step S203 initializes the mixing parameters and the source modelling parameters. The mixing parameters are represented in a matrix W of size I×N×M. As opposed to the first embodiment, where each source is separately modelled using its own basis and activation matrix, the second embodiment has a common basis matrix B and common activations matrix H. Basis matrix B is of size I×K and activations matrix H is of size K×J. Basis matrix B contains K number of basis vectors. To allocate parts of the basis matrix B to each source, an allocation matrix Z is used. Z is a matrix of size N×K and

Z={z̅ₙ}, 1≤n≤N,

where

z̅ₙ

is a vector of size K whose elements

z_{k,n}, 1≤k≤K

indicate the contribution of k^{th} basis vector to the n^{th} source. Unlike NPL 2 where the total contribution of every basis vector is 100%

(Σₙz_{k,n}=1∀1≤k≤K),

we do not impose such a restriction on the total contribution of a particular basis. Hence the vector

z̅ₙ

can also be interpreted as a reliability vector where the K values in vector

z̅ₙ

represent the reliability of K basis vectors of B in modelling the n^{th} source. In total, the n^{th} source is modelled by scaling each of the basis vectors in B with the reliabilities from the vector

z̅ₙ

and then multiplying it with the activation vectors in H.

The matrix decomposition of multi-channel feature data X is optimized in the loop indicated by steps S204 to S210 until convergence. Step S204 estimates the reconstruction error ERR similar to that of step S104. However, this reconstruction is obtained by mixing each of the N sources being estimated as

(z̅ₙ∘B)H, 1≤n≤N

with the mixing matrix W. Here

∘

indicates the multiplication of each element of vector

z̅ₙ

with the entire corresponding basis vector in the matrix B. The product of

(z̅ₙ∘B)

and H is a multiplication of matrices and results in a matrix of size I×J. The reconstruction of Xₘ (m^{th} channel of X) is estimated mathematically as

Xₘ≅Σₙw̅_{m,n}∘[(z̅ₙ∘Bₙ)Hₙ].

The term

(z̅ₙ∘Bₙ)Hₙ

contains J columns each of size I, Each of which are multiplied element wise with the mixing vector

w̅_{m,n}

of size I. The product

w̅_{m,n}∘[(z̅ₙ∘Bₙ)Hₙ]

represents the transformation of n^{th} source as recorded by the m^{th} channel. The sum of transformations of all N sources estimates the recorded data of the m^{th} channel i.e. Xₘ. When calculating the reconstructed mixed frequency data, a basis matrix common to all the data, an activations matrix common to all the data and a reliability matrix detailing the contribution of each basis vector to each data, are used.

The convergence check is performed by step S205 similar to that of step S105. When convergence is not reached, step S205 leads to steps S206 until S210. We again note that the steps S206 to S210 need not be in any particular order as they are update steps of parameters W, Z, B and H.

Step S206 updates and optimizes the content of the mixing matrix W similar to step S106. Box 207 updates and optimizes both contents and sizes of common basis matrices B. Similarly, step 208 updates and optimizes both the contents and sizes of each source's basis matrices H. Step 209 updates and optimizes the contents of each source's reliability vectors in Z. Step 210 extracts the top values of reliabilities of basis vector. The number of top reliable values determines the updated combined complexity of all sources as estimated for that iteration. Basis vectors which are less reliable for all the sources can be ignored from future iterations. This is size update of B, as explained above in step S207.

After iteratively optimizing the parameters W, Z, B and H until convergence is reached, we move from the step S205 to step S211. In step S211, the multi-channel spectrogram X is unmixed using the estimated mixing matrix similar to step S111. Step S212 converts the N estimated source spectrograms back to N raw audio signals similar to step S112. Finally the N estimated audio sources are outputted into the step S213 and the process flow stops.

<Simple Case of Source Separation Device>

So far, we have detailed the block diagram of the second embodiment using an illustration of a process flow of the source separation algorithm as proposed by the present invention. Henceforth, we further attempt to illustrate the optimization steps S206 to S210 of the process flow shown in FIG. 4. This is done by detailing an application that illustrates an improvement of the source separation method detailed in prior art NPL 2 and can be understood by a person fairly familiar with this topic.

NPL 2 illustrates a scenario of separating M sources from M given mixture signals i.e. M=N. It decomposes X into an unmixing matrix and models the sources using a set of non-negative basis and activation matrices. Therefor the initialization step S203 initializes the basis and activation matrices B and H using non-negative random values between 0 and 1. It initializes the mixing matrix W of size I×M×M as {W, =Identity matrix of size M×M, 1≤i≤I}.

All the steps except for S206 until S210 are fairly well known and/or detailed in literature. So we detail the improvements from steps S206 until S210.

Step S206 updates and optimizes contents of W using similar equations as mentioned in the first embodiment. However NPL 2 models the variance of m^{th} source r_{ij,m} as

r_{ij,m}=Σₖz_{k,m}b_{ik,m}h_{kj,m},

where

Σₘz_{k,m}=1∀1≤k≤K.

Here bᵢₖ are the elements of the basis matrix of the B where the k^{th} basis vector

b̅ₖ={bᵢₖ}, 1≤i≤I.

Similarly, h_kj are the elements of activations matrix H, where the k\hat{ }th activation vector

h̅ₖ={hₖⱼ}, 1≤j≤J.

Cost function Q defined is similar to the definition in first embodiment. The method in the second embodiment of the present invention models r_{ij,m} without any restriction on the values of z_{k,m}. z_{k,m} represents the contribution of basis vector

b̅ₖ

in modelling the m^{th} source. So the overall contribution of basis vector

b̅ₖ

is the sum of its contributions of all sources i.e.

Σₘz_{k,m}.

This overall contribution of basis vector

b̅ₖ

is referred to as its reliability. A higher overall contribution of a basis vector implies that is more reliable. Our approach is similar as before: to start with a large value for K and gradually identify the most reliable basis vectors and ignore the less reliable basis.

To do optimization of B, H and Z as described in steps S207, S208 and S209, we can use, however not limited to, variational inference techniques. In such inference techniques, the source parameters i.e. Z, B and H can be modelled from gamma processes as

distribution of bᵢₖ˜Gamma(a₀,a₀),

distribution of hₖⱼ˜Gamma(b₀,b₀),

distribution of z_{k,m}˜Gamma(c₀,cₘ),

where a₀, b₀ and c₀ are some positive constants (which do not have much effect on the overall source modelling) and finally

cₘ=c₀(IJK)[ΣᵢΣⱼ(w̅^{h}_{i,m}x̅ᵢⱼ)²]⁻¹.

In this variational inference application, the source parameters are inferred from a conditional distribution (cond. distr.) on a family of Generalized Inverse-Gaussian (GIG) distributions by estimating appropriate their hyper parameters as

cond. distr. bᵢₖ˜GIG(a₀,ρᵢₖ^{B},τᵢₖ^{B}),

cond. distr. hₖⱼ˜GIG(b₀,ρₖⱼ^{H},τₖⱼ^{H}),

cond. distr. of z_{k,m}˜GIG(c₀,ρ_{k,m}^{Z},τ_{k,m}^{Z}),

where the tuples

(τ^{B},τ^{B}), (ρ^{H},τ^{H}) and (ρ^{Z},τ^{Z})

are the hyper parameters of Basis matrix, Activations matrix and each source's Reliability vector respectively. Values of z_{k,m}, bᵢₖ and hₖⱼ are estimated from the mean of their respective family of GIG conditional distributions. We skip the derivation here and give the update rules of each of hyper parameter when maximizing the cost function Q as below

$${ρ}_{i k}^{B} = {a}_{0} + {\sum }_{m} {\sum }_{j} \frac{{z}_{k , m} {h}_{kj}}{{\sum }_{{k}^{Z} k , m} {b}_{i k} {h}_{k j}} , \\ {τ}_{i k}^{B} = {\sum }_{m} {\sum }_{j} \frac{{( {{\overline{w}}^{h}}_{i , m} {\overline{x}}_{i j} )}^{2} {Φ}_{ijk , m}^{2}}{{z}_{k , m} {h}_{k j}} , \\ {ρ}_{k j}^{H} = {b}_{0} + {\sum }_{m} {\sum }_{i} \frac{{z}_{k , m} {b}_{ik}}{{\sum }_{{k}^{Z} k , m} {b}_{i k} {h}_{k j}} , \\ {τ}_{kj}^{H} = {\sum }_{m} {\sum }_{i} \frac{{( {{\overline{w}}^{h}}_{i , m} {x}_{ij} )}^{2} {Φ}_{ijk , m}^{2}}{{z}_{k , m} {b}_{ik}} , \\ {ρ}_{k , m}^{Z} = {c}_{m} + {\sum }_{i} {\sum }_{j} \frac{{b}_{i k} {h}_{k j}}{{\sum }_{{k}^{Z} k , m} {b}_{i k} {h}_{k j}} , \\ {τ}_{k , m}^{Z} = {\sum }_{i} {\sum }_{j} \frac{{( {{\overline{w}}^{h}}_{i , m} {\overline{x}}_{ij} )}^{2} {Φ}_{ijk , m}^{2}}{{b}_{ik} {h}_{k j}} ,$$

and the parameter

Φ_{ijk,m}

is defined as

$${Φ}_{ijk , m} = \frac{{( {z}_{k , m} {b}_{ik} {h}_{kj} )}^{- 1}}{{{Σ}_{k} ( {z}_{k , m} {b}_{ik} {h}_{kj} )}^{- 1}} .$$

Finally the step S210 is where thresholding of the overall reliability value for each basis vector is done. Gradually over a sufficient number of iterations, convergence of the optimization is reached and combined complexity of all sources is efficiently estimated. Note that less reliable basis vectors have less contribution in modelling every source and overall do not have any impact on the source modelling. Therefore thresholding or identifying top reliable basis is only done so that the less reliable basis vectors can be ignored and thereby improve computational efficiency.

The steps proposed in the second embodiment of the present invention therefore successfully solve the problem of users having to specify an estimate of the combined complexity of all the sources.

A person skilled in the art will appreciate that many embodiments and variations can be made without departing from the ambit of the present invention.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

The program can be stored and provided to the computer device using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to the computer device using any type of transitory computer readable media. Examples of transitory computer readable media include electric signals, optical signals, and electromagnetic waves. Transitory computer readable media can provide the program to the computer device via a wired communication line, such as electric wires and optical fibers, or a wireless communication line.

### INDUSTRIAL APPLICABILITY

The present invention can be applied as a training tool for compensating the data imbalance problem in the techniques of matrix decomposition. One such direct application is the training of a set of audio events for Acoustic Event Detection.

### REFERENCE SIGNS LIST

100, 200, 300, 400 Source separation device
101, 201, 301, 401 Mixture Data Input block
102, 202, 302, 402 Matrix Decomposition block
1021, 2021, 3021, 4021 Estimate Mixing/Unmixing Parameters block
1022 Multi-Source Modelling with Non-Parametric Complexity Estimation of Each Source block
2022 Multi-Source Modelling with Non-Parametric Combined Complexity Estimation of All Sources block
3022 Multi-Source Modelling using the Parameter for Complexity of Each Source block
4022 Multi-Source Modelling using the Parameter for Combined Complexity for All Sources block
1023, 2023, 3023, 4023 Un-mix and Estimate Individual Sources block
103, 203, 303, 403 Separated Data Output block
501 Source Separation unit
502 Microphone
502s Microphones
S₁, S_{N} Audio Source

What is claimed is:

1. A source separation device using matrix decomposition with a non-parametric estimation of source complexity comprising:
at least one memory storing instructions, and
at least one processor configured to execute the instructions to;
input mixture data obtained by mixing a plurality of data; and
calculate mixed frequency data obtained by converting the mixture data into a frequency domain,
iteratively decompose the mixed frequency data based on the number of sources of the plurality of data, into a mixing/unmixing matrix, a basis matrix for each source, a reliability vector for each source, and an activation matrix for each source, until convergence is reached,
estimate a plurality of frequency data after reaching convergence and
convert each of the plurality of estimated frequency data into a time domain to calculate a plurality of estimated data.

2. The source separation device according to claim 1, wherein
the at least one processor further configured to:
use a basis matrix common to all of the plurality of data, an activations matrix common to all of the plurality of data and a reliability matrix detailing the contribution of each basis vector to each of the plurality of data, when estimating the plurality of frequency data.

3. The source separation device according to claim 1, wherein
the at least one processor further configured to:
use at least one of a root mean square error, a mean square error, and log-likelihood when the convergence is performed.

4. The source separation device according to claim 1, wherein
the at least one processor further configured to:
initialize the mixing/unmixing matrix, the basis matrix, the reliability vector, and the activation matrix.

5. The source separation device according to claim 1, wherein
the at least one processor further configured to:
extract the reliability vector in each of the basis matrix equal to or higher than a predetermined reliability.

6. The source separation device according to claim 1, wherein
the at least one processor further configured to:
estimate the plurality of frequency data using a non-parametric extensions of matrix factorization methods.

7. The source separation device according to claim 1, wherein
the plurality of data includes data obtained by using at least one of a sound sensor, a vibration sensor, a vehicle related sensor, a chemical sensor, an electric sensor, a magnetic sensor, a radiation sensor, a pressure sensor, a thermal sensor, an optical sensor, a navigational sensor and a weather sensor.

8. The source separation device according to claim 1, wherein
the at least one processor further configured to: using
use a variational inference technique when estimating the plurality of frequency data.

9. A method for a source separation device using matrix decomposition with a non-parametric estimation of source complexity comprising:
inputting mixture data obtained by mixing a plurality of data;
calculating mixed frequency data obtained by converting the mixture data into a frequency domain;
iteratively decomposing the mixed frequency data based on the number of sources of the plurality of data, into a mixing/unmixing matrix, a basis matrix for each source, a reliability vector for each source, and an activation matrix for each source, until convergence is reached;
estimating a plurality of frequency data after reaching convergence; and
converting each of the plurality of estimated frequency data into a time domain to calculate a plurality of estimated data.

10. A non-transitory computer readable medium storing a program causing a source separation device to execute:
inputting mixture data obtained by mixing a plurality of data;
calculating mixed frequency data obtained by converting the mixture data into a frequency domain;
iteratively decomposing the mixed frequency data based on the number of sources of the plurality of data, into a mixing/unmixing matrix, a basis matrix for each source, a reliability vector for each source, and an activation matrix for each source, until convergence is reached;
estimating a plurality of frequency data after reaching convergence; and
converting each of the plurality of estimated frequency data into a time domain to calculate a plurality of estimated data.
